(19) United States
(12) Patent Application Publication
(10) Pub. No.: US 2010/0008636 A1
(43) Pub. Date: Jan. 14, 2010

(54) VIDEO DISPLAY DEVICE, VIDEO PLAYBACK DEVICE, VIDEO PLAYBACK DISPLAY SYSTEM AND CONTROL METHOD THEREOF

(75) Inventor: Katsuya Ohno, Kokubunji-shi (JP)

Correspondence Address: PATTERSON & SHERIDAN, L.L.P., 3040 POST OAK BOULEVARD, SUITE 1500, HOUSTON, TX, 77056, US

(73) Assignee: Kabushiki Kaisha Toshiba, Tokyo (JP)

(21) Appl. No.: 12/393,190

(22) Filed: Feb. 26, 2009

(30) Foreign Application Priority Data
Jul. 11, 2008 (JP) 2008-181772

(51) Int. Cl. H04N 5/91; H04N 5/66; H04N 3/27

(52) U.S. Cl. 386/46; 348/739; 348/554; 348/E05.133; 348/E03.049

(57) ABSTRACT

According to one embodiment, a video display device includes a first receiver module configured to receive video signals output from the video playback device, a second receiver module configured to receive video signals output from a video source other than the video playback device, a switching module configured to switch connection of video signals output from the first receiver module and the second receiver module, and a command output module configured to output a predetermined command when the connection of the video signals is switched from the first receiver module to the second receiver module.

### CROSS-REFERENCE TO RELATED APPLICATIONS

This application is based upon and claims the benefit of priority from Japanese Patent Application No. 2008-181772, filed Jul. 11, 2008, the entire contents of which are incorporated herein by reference.

### BACKGROUND

1. Field

One embodiment of the present invention relates to a video display device, more particularly, to a video display device, a video playback device, a video playback display system and a control method thereof, capable of controlling a playback device configured to play back video signals according to switching of input of the video signals.

2. Description of the Related Art

In general, a video display device such as a television is compatible with a plurality of input sources, and can display video signals by switching between those originating as broadcast signals and those from an externally connected video playback device. Jpn. Pat. Appln. KOKAI Publication No. 2008-34965, for example, discloses a technique of switching input from a television to a device equipped with a video playback function, when the device equipped with the video playback function makes a request for input switching to a television via a High-Definition Multimedia Interface (HDMI) connection.

In the technique disclosed in Jpn. Pat. Appln. KOKAI Publication No. 2008-34965, however, when switching of input of video signals is performed by a television, a video playback device connected to the television cannot start or stop playback in conjunction with the input switching of the video signals by the television side.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary conceptual diagram showing a configuration of a video playback display system according to an embodiment of the present invention.

FIG. 2 is an exemplary block diagram showing a main configuration of a video display device according to the embodiment.

FIG. 3 is an exemplary block diagram showing a main configuration of the video display device according to the embodiment.

FIG. 4 is an exemplary flowchart illustrating the procedure of a control method (first control method) to which the video playback display system and the video display device according to the embodiment are applied.

FIG. 5 is an exemplary flowchart for illustrating the operation of a control method (second control method) to which the video playback display system and the video playback device according to the embodiment are applied.

FIG. 6 is an exemplary flowchart illustrating the procedure of the control method (second method) to which the video playback display system and the video display device according to the embodiment are applied.

FIG. 7 is an exemplary flowchart illustrating the procedure of the control method (first method) to which the video playback display system and the video playback device according to the embodiment are applied.

FIG. 8 schematically shows an example of table information in which control commands used in the video playback display system, the video playback device, and the video display device according to the embodiment are stored.

### DETAILED DESCRIPTION

Various embodiments according to the invention will be described hereinafter with reference to the accompanying drawings. In general, according to one embodiment of the invention, a video display device includes: a first receiver module configured to receive video signals output from the video playback device; a second receiver module configured to receive video signals output from a video source other than the video playback device; a switching module configured to switch connection of video signals output from the first receiver module and the second receiver module; and a command output module configured to output a predetermined command when the connection of the video signals is switched from the first receiver module to the second receiver module.

Hereinafter, an embodiment of the present invention will now be described with reference to the drawings.

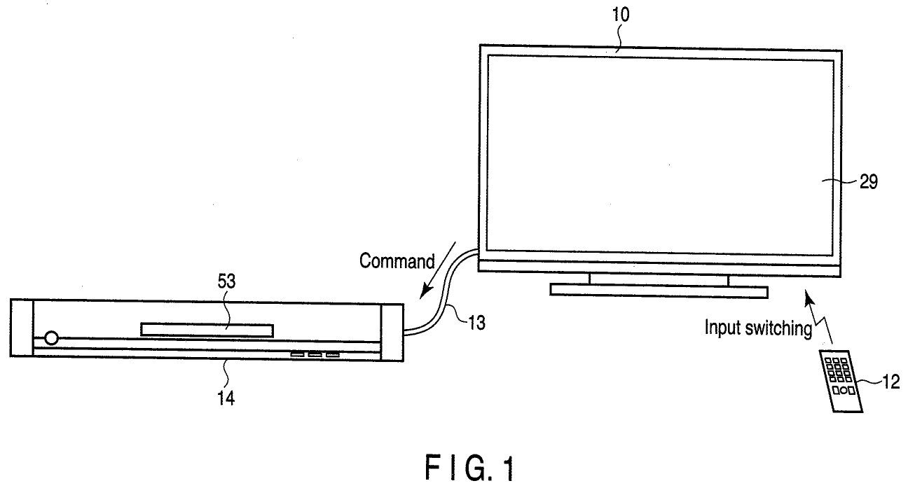

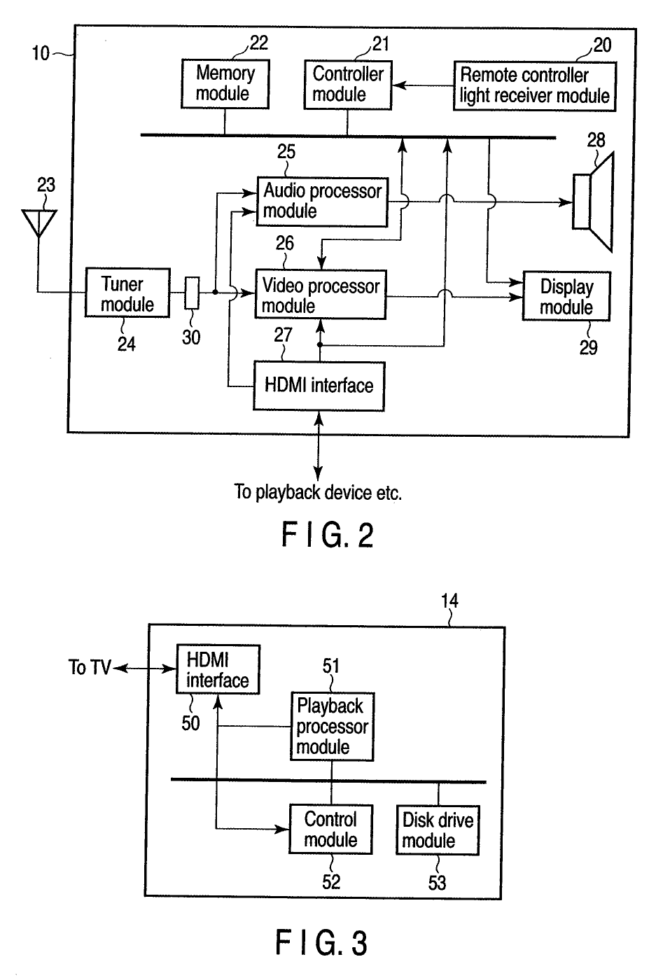

First, the video playback display system and the video display device according to an embodiment of the present invention will now be described with reference to FIGS. 1 and 2.

As shown in FIG. 1, a video playback display system comprises a video playback device 14 such as a DVD player and a video display device 10 such as a television. In the present embodiment, the video playback device 14 will be described as a DVD player capable of playing back optical discs, for example, but may be any device capable of playing back video signals, such as a device into which a hard disk drive (HDD) is built and which is capable of playing back content stored in the HDD.

The video playback device 14 comprises a disk drive module 53 which plays back optical discs, for example, and is connected to the video display device 10 via a High-Definition Multimedia Interface (HDMI) cable 13. The video display device 10 comprises a display module 29 such as a display, and displays video signals input from the video playback device 14 connected via HDMI, for example, on the display module 29. Further, video signals from other externally connected video source devices and originating as broadcast signals received by a built-in tuner are also displayed on the display module 29. Input switching between these video signals is performed by a controller module (which will be described below) included in the video display device 10. Input switching of video signals is performed when the video display device 10 transmits a predetermined command to the video playback device 14.

Input switching between these video signals can be performed based on an instruction from a remote controller 12 included with the video display device 10, for example. Input switching between the video signals may be performed by pressing down a predetermined button included in the video display device 10. In the present embodiment, the video display device 10 and the video playback device 14 are connected via an HDMI cable, but may be connected wirelessly over the radio. The connection form is not limited to a specific one and may be any form in which the video display device 10 can transmit a predetermined command to the video playback device 14.

FIG. 2 is a block diagram showing a main configuration of the video display device 10. The video display device 10 comprises a remote controller light receiver module 20, a controller module 21, a memory module 22, a broadcast signal reception antenna 23, a tuner module 24, an audio processor module 25, a video processor module 26, an HDMI interface (first receiver module) 27, a speaker 28, a display module 29, a broadcast signal input module (second receiver module) 30, and the like.

The remote controller light receiver (command receiver module) 20 is an interface device which receives a signal such as an input switch request signal from the remote controller 12 and transfers the signal to the controller module 21. The controller module (switching module; command output module) 21 performs image processing of video signals received from the video playback device 14 and originating as broadcast signals and displays the signals on the display module 29. The controller module 21 performs switching of video signals input via the HDMI interface 27. When switching of the input video signals is performed, the controller module 21 transmits a predetermined command stored in the memory module 22 to the video playback device 14. When switching of the input video signals is performed, the memory 22 stores a command (which will be described later; see FIG. 8) which is transmitted to the video playback device 14. The broadcast signal reception antenna 23 is an antenna which receives broadcast signals transmitted from a broadcast station. The tuner module 24 is a tuner which synchronizes the broadcast signals received by the antenna 23 to frequencies of the respective broadcast stations. The audio processor module 25 is a device configured to process audio data included in video signals output from the tuner module 24 and process the audio data to cause the speaker 28 to output audio. The video processor module 26 processes video data included in the video signals output from the tuner module 24 and processes the video data to display the video data on the display module 29. The HDMI interface 27 is an interface device used for connection with an external connection device such as the image playback device 14. The speaker 28 is an audio device from which audio data included in the video signals output from the tuner module 24 and processed by the audio processor 25 is output. The display module 29 is a display device which displays video data included in video signals output from the tuner module 24 and processed by the video processor module 26. The broadcast signal input module 30 divides the broadcast signal received by the tuner 24 into audio data and video data, and transmits the audio data and the video data to the audio processor module 25 and the video processor module 26, respectively.

FIG. 3 shows a block diagram showing a main configuration of the video playback device 14.

The video playback device 14 comprises an HDMI interface 50, a playback processor module 51, a controller module 52, a disk drive module 53, and the like. The HDMI interface 50 is an interface device for connection with a device which displays video, such as the video display device 10. The playback processor module 51 performs a playback operation to decode video signals read from an optical disk, for example, by the disc drive module 53. The controller module 52 outputs video signals via the HDMI interface 50 based on video data decoded by the playback processor module 51. The controller module 52 performs an operation according to a command received from the video display device 10. For example, when the received command indicates a playback request, an optical disc, for example, is played back by the disk drive module 53. The disc drive 53 reads video signals from a recording medium such as an optical disc.

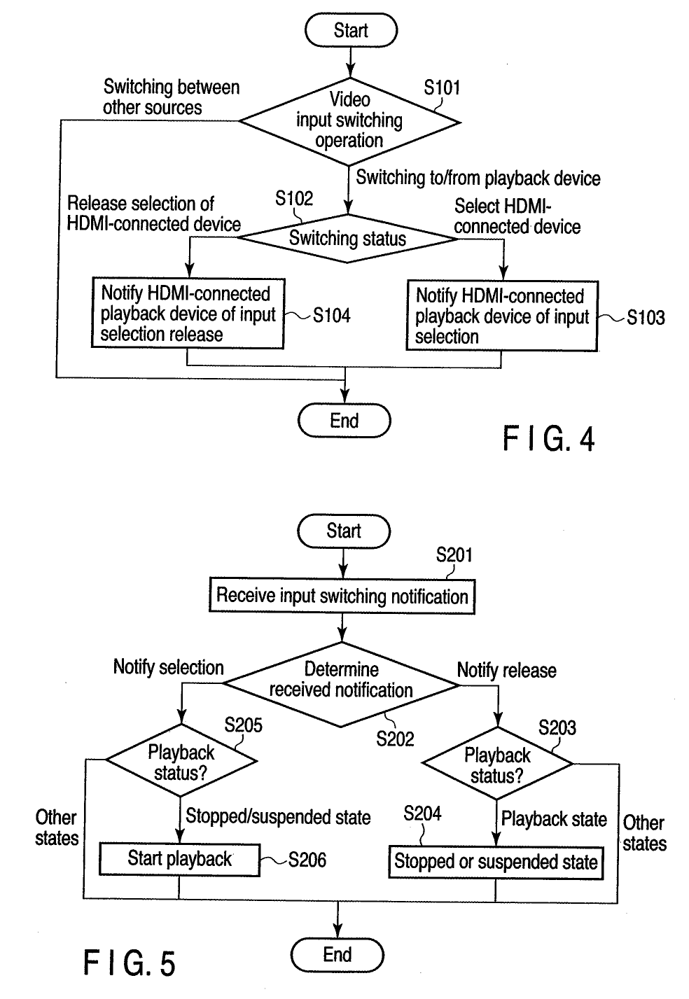

The procedures for the video playback display system and the control method to which the video playback display is applied with the above-described configuration according to the present invention will now be described with reference to the flowcharts shown in FIGS. 4-7.

There are two ways to control the video playback device 14 in conjunction with the input switching of video signals input to the video display device 10. In the first method, input switching of the video display device 10 is performed, and a selection command indicating that video signals output from the video playback device 14 has been selected or a release command indicating that selection of output of video signals from the video playback device 14 has been released is transmitted from the video display device 10 to the video playback device 14. The video playback device 14 starts playback upon receipt of the selection command and stops or suspends playback upon receipt of the release command.

In the second method, when input switching of the video display device 10 is performed, a command requiring the playback status is transmitted from the video display device 10 to the video playback device 14. Upon receipt of this command, the video playback device 14 transmits status notification information about whether the video playback device 14 is in a playback state or a stopped or suspended state to the video display device 10. The video display device 10 transmits a command requiring start of playback when the received status notification information indicates that the video playback device 14 is in the stopped or suspended state.

FIG. 4 is a flowchart illustrating the procedure of the video display device 10 such as a television according to the first method. FIG. 5 is a flowchart showing the procedure of the video playback device 14 such as a DVD player according to the first method.

The controller module 21 of the video display device 10 monitors whether a video input switching operation has been performed or not. As shown in FIG. 4, when the controller module 21 of the video display device 10 determines that an input switching request has been received from the remote controller 12, for example, and a video input switching operation from/to the video playback device 14 has been performed (such as switching from broadcast signals to the video playback device 14 or vice versa) (“Switching to/from playback device” in block S101), the procedure advances to block S102. When the controller 21 of the video display device 10 determines in block S101 that input switching between other video sources (between terrestrial broadcasting and satellite broadcasting, for example) (“Switching between other sources” in block S101), the procedure is finished.

In block S102, the controller module 21 of the video display device 10 determines the switching status of input switching of the video display device 10. When the controller module 21 of the video display device 10 determines in block S102 that input from the video playback device 14 has been selected (when input has been switched from broadcast signals to the video playback device 14, for example), a command indicating selection of input from the video playback device 14 is transmitted to a playback device connected via HDMI, such as the video playback device 14. When the controller 21 of the image display device 10 determines in block S102 that input from the video playback device 14 has been released (such as when input has been switched from the video display device 14 to broadcast signals) (“Release HDMI-connected device” in block S102), a command indicating release of input from the video playback device 14 is transmitted to an HDMI connection playback device such as the video playback device 14 (block S104). The command indicating selection of input from the video display device 14 or the command indicating release of input from the video playback device 14 can be accomplished by using Vendor Specific Commands defined as Consumer Electronic Control (CEC) commands of HDMI. The following command will be preset for example.

Input selected command

Initiator: TV (Video display device 10)

Destination: Currently active source (Video display device 14)

Opcode: <Vendor Command>

Parameter: select

Input released command

Initiator: TV (Video display device 10)

Destination: Currently active source (Video display device 14)

Opcode: <Vendor Command>

Parameter: cancel

Next, as shown in FIG. 5, upon receipt of a command requiring input switching from the video display device 10 (block S201), the controller module 52 of the video playback device 14 determines the received command (block S202). When the controller module 52 determines in block S202 that the received command is the input selected command (“Selection notification” in block S202), the video display device 14 determines the playback status of the video display device 14 itself (block S205). When the controller module 52 of the video playback device 14 determines in block S205 that the playback status of the video playback device 14 is in a stopped or suspended state (“Stopped/suspended state” in block S205), playback of an optical disc, for example, by the video playback device 14 is started (block S206). When the controller module 52 of the video playback device 14 determines in block S205 that the video playback device 14 is in a state other than the stopped or suspended state (“Other states” in block S205), the procedure is finished (by ignoring the received “input selected command”).

When the controller module 52 of the video playback device 14 determines in block S202 that the received command is the input released command (“Release notification” in block S202), the video playback device 14 determines the playback status of the video playback device 14 itself (block S203). When the controller 52 of the video playback device 14 determines in block S203 that the video playback device 14 is in a playback state (“Playback state” in block S203), playback of an optical disc, for example, by the video display device 14 is stopped or suspended (block S204). When the controller 52 of the video playback device 14 determines in block S203 that the video playback device 14 is in a state other than the playback state (“Other states” in block S203), the procedure is finished (by ignoring the received “input released command”).

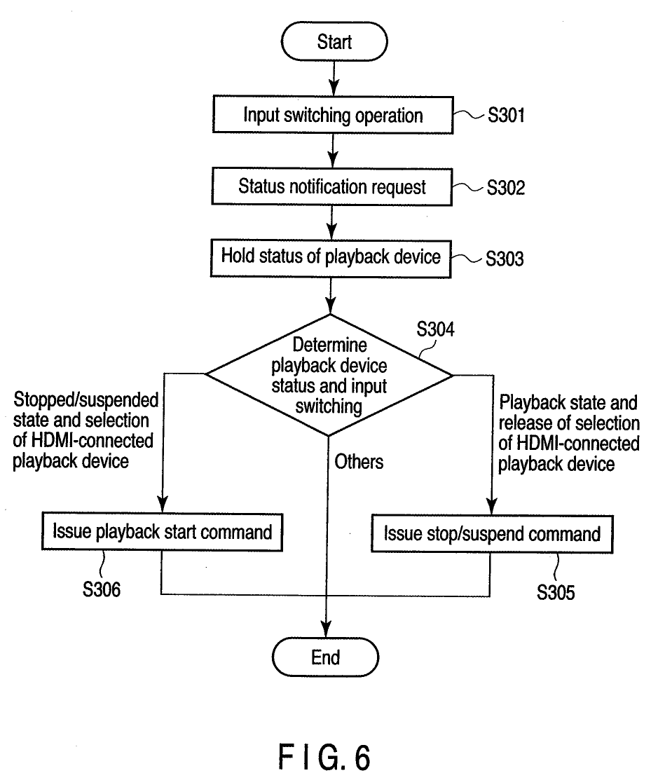

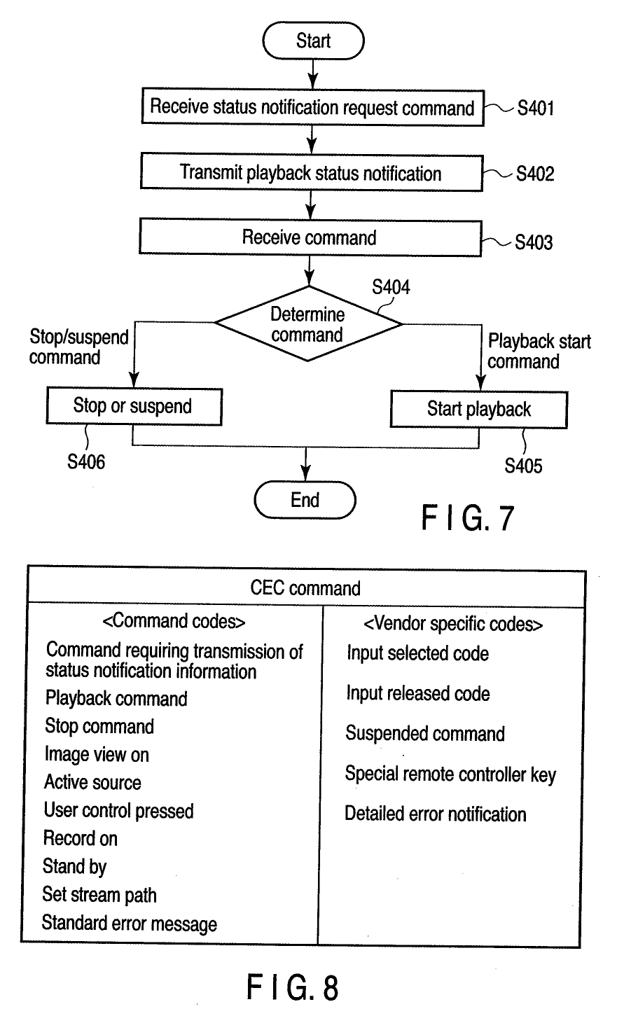

FIG. 6 is a flowchart illustrating the procedure of the video display device 10 such as a television, according to the second method. FIG. 7 shows a flowchart illustrating the procedure of the video playback device 14 such as a DVD player, according to the second method.

The video display device 10 monitors whether a video input switching operation has been performed or not. As shown in FIG. 6, when an input switching request is received from the remote controller 12 and a video input switching operation is performed (block S301), the video display device 10 transmits a command requiring transmission of status notification information indicating the playback status of the image playback device 14. The command requiring transmission of status notification information can be accomplished by using Deck Control defined as a Consumer Electronics Control (CEC) command of HDMI. The following command will be preset, for example.

Command requiring transmission of status notification information

Initiator: TV (Video display device 10)

Destination: Currently active source (Video playback device 14)

Opcode: <Give Deck Status>

The video display device 10 receives status notification information indicating the playback status of the video playback device 14 from the video playback device 14 and holds (stores) the status notification information in the memory module 22, for example (block S303). The video display device 10 determines the playback status of the video playback device 14 and input switching based on the received status notification information (block S304). When the controller module 21 of the video display device 10 determines in block S304 that the video playback device 14 is in the playback state and that selection of the video playback device 14 connected via HDMI is released (“Playback state and release of selection of HDMI-connected playback device” in block S304), the video display device 10 issues and transmits a command requiring stop or suspension to the video playback device 14 (block S305). When the controller 21 of the video display device 10 determines in block S304 that the video playback device 14 is in a stopped or suspended state and that the video playback device 14 connected via HDMI has been selected (“Stopped/suspended state and selection of HDMI-connected playback device” in block S304), the video display device 10 issues and transmits a command requiring start of playback to the video playback device 14 (“Issue playback start command” in block S305). The command requiring stop or suspension and the command requiring start of playback can be accomplished by using Deck Control defined as Consumer Electronics Control (CEC) commands of HDMI. If specific commands do not exist, Vendor Specific Commands may be used to accomplish the commands.

For example,

Stop command

Initiator: TV (Video Display device 10)

Destination: Currently active source (Video display device 14)

Opcode: <Deck Control>

Parameter: stop

Playback start command

Initiator: TV (Video display device 10)

Destination: Currently active source (Video playback device 14)

Opcode: <Play>

Suspension command

Initiator: TV (Video display device 10)

Destination: Currently active source (Video playback device 14)

Opcode: <Vendor Command>

Parameter: pause

Next, the video playback device 14 receives a status notification request command (requiring transmission of status notification information) from the video display device 10, as shown in FIG. 7. The video playback device 14 transmits status notification information (information on the playback status) indicating the playback status of the video playback device 14 according to the status notification request command (block S402). Upon receipt of the status notification information transmitted from the video playback device 14, the video display device 10 transmits “stop or suspension command” or “playback start command” to the video playback device 14. Upon receipt of these commands (block S403), the video playback device 14 determines the received command (block S404). When the controller module 52 of the video playback device 14 determines that the received command is the playback start command (“Playback start command” in block S404), playback of content on an optical disc, for example, by the video playback device 14 is started (block S405). When the controller module 52 of the video playback device 14 determines in block S404 that the received command is the stop or suspension command (“Stop/suspend command” in block S404), playback of content on an optical disc, for example, by the video playback device 14 is stopped/suspended. The above-described modules may be accomplished either as software or hardware.

It is therefore an object of the present invention to provide a video display device, a video playback device, a video playback display system and a control method thereof, capable of starting and stopping playback in conjunction with input switching of video signals by the television side.

According to the above-described embodiment, playback of the video playback device connected in conjunction with input switching of video signals by the video display device such as a television can be started or stopped. The user only needs to operate the video display device 10 and switching is automatically performed, without the need to make complicated operations on the video playback device 14. Thereby, improved user-friendliness can be achieved.

Further, the present invention is not limited to the above-described embodiment. The present invention can be embodied by modifying structural elements within the range of the spirit or scope of the invention.

Further, various inventions can be made by combining the structural elements disclosed in the above-described embodiment as appropriate. For example, some of the structural elements may be deleted from all the structural elements disclosed in the embodiment. Moreover, the structural elements of different embodiments may be combined as appropriate.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video display device comprising:
a first receiver module configured to receive video signals output from the video playback device;
a second receiver module configured to receive video signals output from a video source other than the video playback device;
a switching module configured to switch connection of video signals output from the first receiver module and the second receiver module; and
a command output module configured to output a predetermined command when the connection of the video signals is switched from the first receiver module to the second receiver module.

2. A video display device comprising:
a first receiver module configured to receive video signals output from the video playback device;
a second receiver module configured to receive video signals output from another video source different from the video playback device;
a switching module configured to switch connection of video signals output from the first receiver module and the second receiver module; and
a command output module configured to output a predetermined command when the connection of the video signals is switched from the second receiver module to the first receiver module.

3. The video display device of claim 1, wherein the predetermined command is a selection command indicating selection of the video playback device or a release command indicating release of selection of the video playback device.

4. The video display device of claim 2, wherein the predetermined command is a selection command indicating selection of the video playback device or a release command indicating release of selection of the video playback device.

5. The video display device of claim 1, wherein the predetermined command is a playback command indicating a request for a playback operation by the video playback device or a stop/suspend command indicating a request for a stop/suspend operation by the video playback device.

6. The video display device of claim 2, wherein the predetermined command is a playback command indicating a request for a playback operation by the video playback device or a stop/suspend command indicating a request for a stop/suspend operation by the video playback device.

7. A video playback device configured to output video signals to a video display device, comprising a first receiver module configured to receive output video signals and a second receiver module configured to receive output video signals different from the output video signals received by the first received module, via the first receiver module, the video display device comprising a switching module configured to switch connection of video signals output from the first receiver module and the second receiver module, the video playback device comprising:
a command receiver module configured to receive a predetermined command from the video display device when connection of video signals is switched from the first receiver module to the second receiver module by the switching module; and
a control module configured to control that the video playback device starts a playback operation when the predetermined command received by the command receiver module is a selection command indicating selection of the video playback device and the video playback device is in a stopped state, and starts one of a stop operation and a suspension operation when the predetermined command is a release command indicating release of selection of the video playback device and the video playback device is in a playback state.

8. A video playback device configured to output video signals to a video display device, comprising a first receiver module configured to receive output video signals and a second receiver module configured to receive output video signals different from the output video signals received by the first receiver unit, via the first receiver module, the video display device comprising a switching module configured to switch connection of video signals output from the first receiver module and the second receiver module, the video playback device comprising:
a command receiver module configured to receive a predetermined command from the video display device when connection of the video signals is switched from the second receiver module to the first receiver module by the switching module; and
a control module configured to control that the video playback device starts a playback operation when the predetermined command received by the command receiver module is a selection command indicating selection of the video playback device and the video playback device is in a stopped state, and performs one of a stop operation and a suspension operation when the predetermined command is a release command indicating release of selection of the video playback device and the video playback device is in a playback state.

9. A video playback display system comprising a video playback device configured to output video signals, and a video display device comprising a first receiver module configured to receive video signals output from the video playback device, a second receiver module configured to receive video signals output from a video source other than the video playback device, and a switching module configured to switch connection of video signals output from the first receiver module and the second receiver module, wherein
the video display device comprises a command output module configured to output a predetermined command to the video playback device when connection of video signals is switched from the first receiver module to the second receiver module by the switching module, and
the video playback device comprises a controller module configured to start a playback operation when the received predetermined command is a selection command indicating selection of the video playback device and the video playback device is in a stopped state, and perform one of a stop operation and a suspension operation when the predetermined command is a release command indicating release of selection of the video playback device and the video playback device is in a playback state.

10. A video playback display system comprising a video playback device, a video display device comprising a first receiver module configured to receive video signals output from the video playback device, a second receiver module configured to receive video signals output from a video source other than the video playback device, and a switching module configured to switch connection of video signals output from the first receiver module and the second receiver module, wherein
the video display device comprises a command output module configured to output a predetermined command to the video playback device when connection of video signals is switched from the second receiver module to the first receiver module by the switching module, and
the video playback device comprises a controller module configured to start a playback operation when the received predetermined command is a selection command indicating selection of the video playback device and the video playback device is in a stopped state, and perform one of a stop operation and a suspension operation when the predetermined command is a release command indicating release of selection of the video playback device and the video playback device is in a playback state.

11. A control method used in a video display device comprises a first receiver module configured to receive video signals output from the video playback device, a second receiver module configured to receive video signals output from a video source other than the video playback device, and a switching module configured to switch connection of video signals output from the first receiver module and the second receiver module, wherein
a predetermined command is output to the video playback device when the switching module switches connection of video signals from the first receiver module to the second receiver module.

12. A control method used in a video display device comprises a first receiver module configured to receive video signals output from the video playback device, a second receiver module configured to receive video signals output from a video source other than the video playback device, and a switching module configured to switch connection between video signals output from the first receiver module and the second receiver module, wherein
a predetermined command is output to the video playback device when the switching module switches connection of video signals from the second receiver module to the first receiver module.

13. The control method of claim 11, wherein the predetermined command is a selection command indicating selection of the video playback device or a release command indicating release of selection of the video playback device.

14. The control method of claim 12, wherein the predetermined command is a selection command indicating selection of the video playback device or a release command indicating release of selection of the video playback device.

15. The control method of claim 11, wherein the predetermined command is a playback command indicating a request for a playback operation by the video playback device or a stop/suspend command indicating a request for a stop/suspend operation by the video playback device.

16. The control method of claim 12, wherein the predetermined command is a playback command indicating a request for a playback operation by the video playback device or a stop/suspend command indicating a request for a stop/suspend operation by the video playback device.
